(19) United States
(12) Patent Application Publication
(10) Pub. No.: US 2005/0179313 A1
(43) Pub. Date: Aug. 18, 2005

(54) Wheel assembly for a cart

(76) Inventor: Kun-Hao Liu, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/779,694

(22) Filed: Feb. 18, 2004

(51) Int. Cl. B60B 23/00

(52) U.S. Cl. 301/111.01

(57) ABSTRACT

A wheel assembly for a cart includes a wheel having an axle hole, a sleeve having a passage defined to communicate with the at least two cutouts in a distal end of the sleeve, an axle extending into the axle hole of the wheel and the passage of the sleeve, the axle having an annular groove to be exposed to the at least two cutouts of the sleeve after the axle is extended into the passage of the sleeve, and a clamp having two distal ends extending into the at least two cutouts to clamp a bottom face defining the annular groove.

### BACKGROUND OF THE INVENTION

1. Field of the Invention

The present invention relates to a wheel assembly, and more particularly to a wheel assembly for a cart. The wheel assembly is composed of a wheel having a centrally defined axle hole, a shoulder formed on an inner side face of the axle hole, and an axle extending into the axle hole. The axle has an annular groove defined in a free end of the axle and a sleeve having a head portion and a body integrally formed with the head portion and having a slit defined in a free end of the sleeve. An annular indentation is orthogonally defined relative to the slit such that after the shoulder is received in the corresponding annular indentation, a clamp inserted from the opening in the head portion is able to secure engagement between the axle and the sleeve.

2. Description of Related Art

A conventional wheel assembly, as shown in FIGS. 7 and 8, for a cart normally is composed of a wheel (5), an axle (6) extending through the wheel (5) and supported by a bracket (not numbered) of the cart (not shown), a cap (7) securely connected to a free end of the axle (6) and a spring (8) mounted around the axle (6). The spring (8) is sandwiched between the bracket and the wheel (5) to push the wheel (5) to engage with the cap (7) such that the wheel (5) is not slidable on the axle (6). In order to prevent direct friction between the wheel (5) and the cap (7), a clamp (9) is sandwiched between the cap (7) and the wheel (5) to secure a free end of the axle (6).

When the conventional wheel assembly is used, the wheel (5) tends to wobble easily and thus causes uneven friction to the wheel (5) by the clamp (9). Furthermore, it is not easy for the user to self-assemble the wheel assembly. After the free end of the axle (6) is clamped by the clamp (9), the cap (7) has no substantial function but only serves to decorate the overall appearance of the conventional wheel assembly.

To overcome the shortcomings, the present invention tends to provide an improved wheel assembly to mitigate the aforementioned problems.

### SUMMARY OF THE INVENTION

The primary objective of the present invention is to provide an improved wheel assembly to enable the user to easily assemble the entire wheel assembly.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the wheel assembly of the present invention; a perspective view of the wheel assembly of the present invention;

FIG. 2 is a cross sectional view showing the assembled wheel assembly of the present invention;

FIG. 3 is a schematic side view showing the clamp is implemented to clamp the axle extending into the wheel;

FIG. 4 is a perspective view showing the wheel assembly of the present invention;

FIG. 5 is a schematic perspective view showing the application of the wheel assembly in a cart;

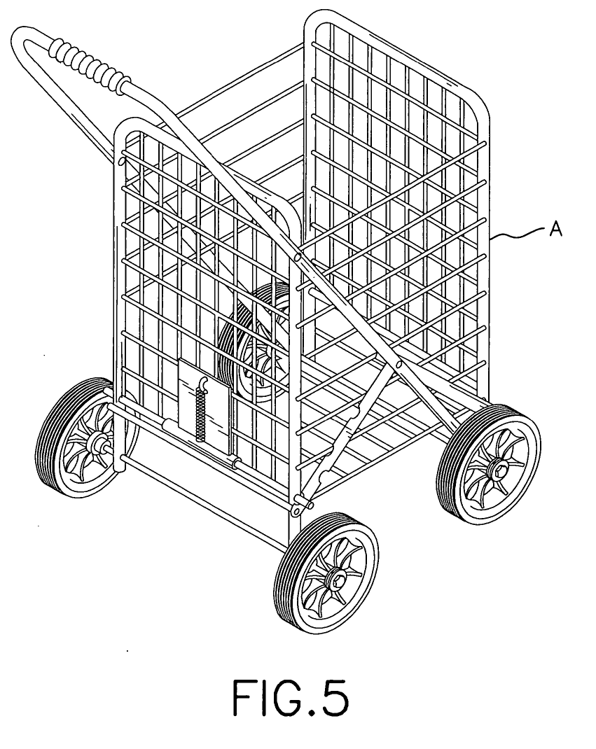

FIG. 6 is a schematic side view showing that the cart in FIG. 5 is folded;

FIG. 7 is a perspective view showing a conventional wheel assembly; and

FIG. 8 is a schematic cross sectional view of the conventional wheel assembly in FIG. 5.

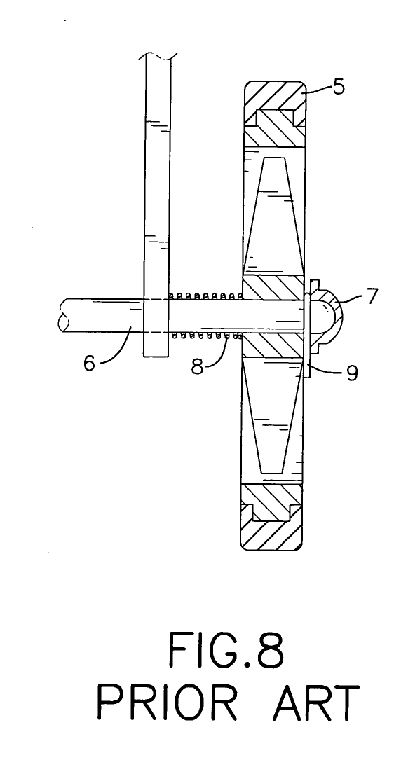

### DETAILED DESCRIPTION OF THE PREFERRED EMBODIMENT

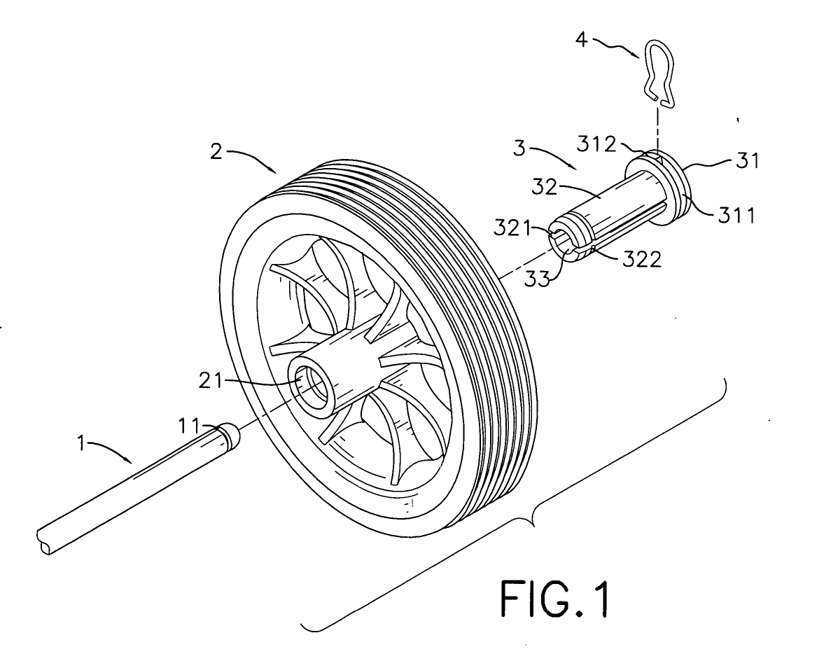

With reference to FIG. 1, the wheel assembly in accordance with the present invention has an axle (1), a wheel (2), a sleeve (3) and a clamp (4).

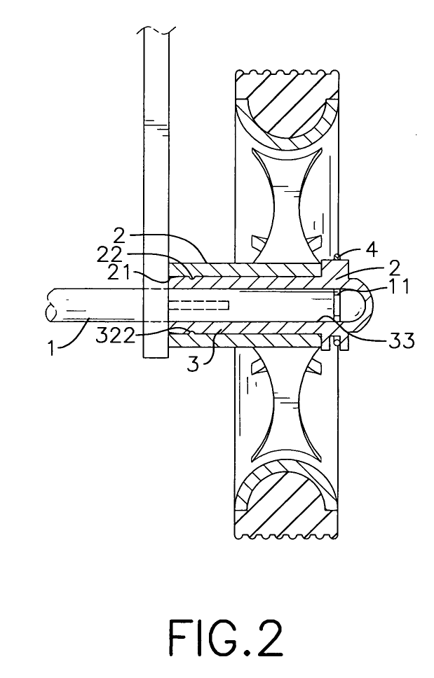

The axle (1) is cylindrical and has an annular groove (11) close to a distal end of the axle (1). The wheel (2) has a centrally defined axle hole (21) and a shoulder (22) (as shown in FIG. 2) formed on an inner face defining the axle hole (21).

Referring to FIG. 2, the sleeve (3) has a head portion (31) and a body portion (32) integrally formed with the head portion (31) and having a diameter smaller than the diameter of the head portion (31). The head portion (31) has at least two cutouts (311) defined in the head portion (31) and thus at least two stops (312) formed between the at least two cutouts (311). The body portion (32) has a slit (321) axially defined in the body portion (32) to separate a free end of the body portion to two halves, an annular indentation (322) laterally defined in the body portion (32) to correspond to the shoulder (22) of the wheel (2) and a passage (33) in communication with the slit (321) and the at least two cutouts (311).

The clamp (4) has two distal ends and a configuration corresponding to either one of the stops (312).

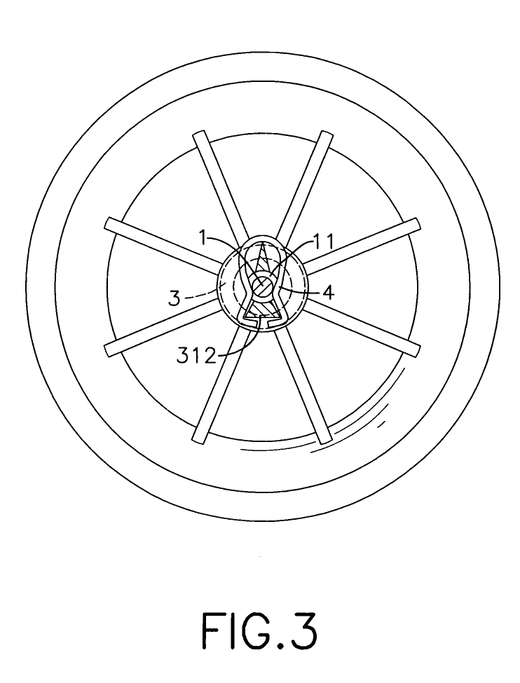

With reference to FIGS. 2 and 3, when the wheel assembly of the present invention is to be assembled, the sleeve (3) is extended into the axle hole (21) to have the shoulder (22) received in the corresponding annular indentation (322). Due to the provision of the slit (321), the two halves of the body portion (32) provide a resilience to allow the two halves to move toward each other such that after the shoulder (22) is received in the annular indentation (322), the sleeve (3) is securely received in the axle hole (21) of the wheel (2). Then the axle (1) is extended into the axle hole (21) of the wheel (2) and the passage (33) of the sleeve (3) to abut a bottom face defining the passage (33). The annular groove (11) is exposed to the at least two cutouts (311) and the two distal ends of the clamp (4) are able to be extended into the two cutouts (311) to have one of the at least two stops (312) received in the clamp (4) and clamp a bottom face defining the annular groove (11).

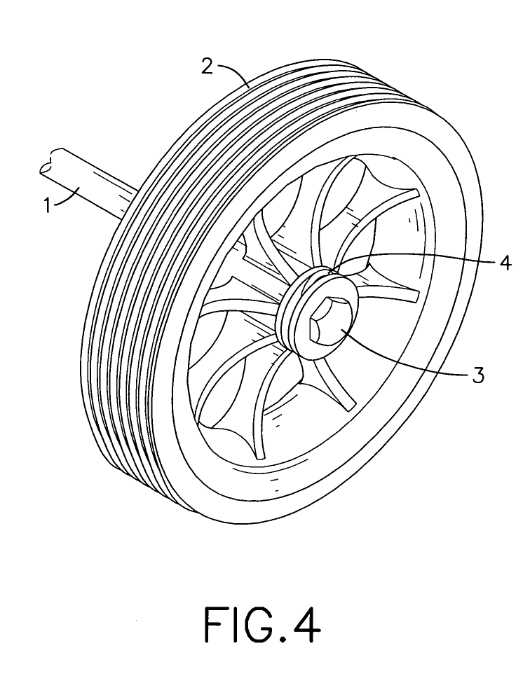

With reference to FIG. 4, it is noted that the wheel assembly of the present invention is simple in structure and very easy to be assembled in that after the components of the wheel assembly are produced, the operator is able to easily combine every component together. Once the sleeve (3) is secured in the axle hole (21) of the wheel (2), the axle (1) can be extended into the axle hole (21) and the passage (33) of the sleeve (3) and then the clamp (4) is used to clamp the bottom face defining the annular groove (11) whereby the entire structure is secured with ease.

Furthermore, before the cart is sold to the customer, the wheel (2), the sleeve (3) and the clamp (4) are already assembled. Therefore, the customer only needs to extend the axle (1) into the axle hole (21) to have the clamp (4) to clamp the annular groove (11) to complete the assembly. Thus the customer only needs a simple process to complete the assembly.

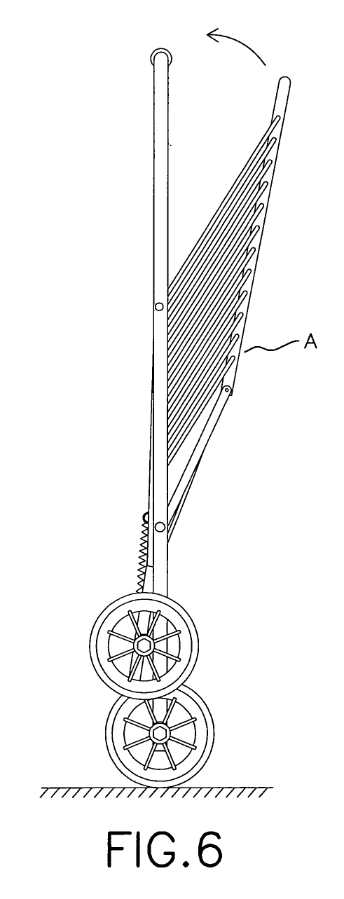

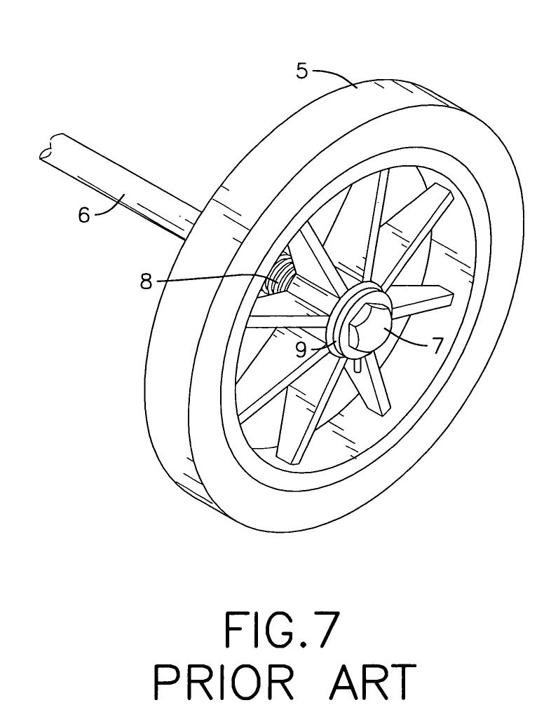

With reference to FIGS. 6 and 7, it is noted that the wheel assembly constructed in accordance with the present invention is combined with a cart (A) with which the user is able to load goods therein. With the advantages of the present invention, the user is able to easily assemble the wheel assembly to the cart (A).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A wheel assembly for a cart, the wheel assembly comprising:
a sleeve having a head portion having at least two cutouts defined in the head portion and a body portion integrally formed with the head portion and corresponding to and securely received in the axle hole of the wheel, the body portion having a passage defined in the body portion to communicate with the at least two cutouts;
an axle extending into the axle hole of the wheel and the passage of the sleeve, the axle having an annular groove to be exposed to the at least two cutouts of the sleeve after the axle is extended into the passage of the sleeve;
a wheel having an axle hole centrally defined through the wheel to correspond to the axle; and
a clamp having two distal ends extending into the at least two cutouts to clamp a bottom face defining the annular groove.

2. The wheel assembly as claimed in claim 1, wherein a shoulder is formed on an inner side face defining the axle hole, the body portion of the sleeve has an annular indentation formed on the body portion to correspond to the shoulder such that after the body portion of the sleeve is extended into the axle hole, the shoulder is received in the annular indentation.

3. The wheel assembly as claimed in claim 2, wherein the body portion of the sleeve has a slit to separate the body portion into two halves such that a resilience is provided to the two halves to allow the two halves of the body portion to move toward each other when the body portion is extended into the axle hole.
